(19) United States
(12) Patent Application Publication
(10) Pub. No.: US 2008/0291002 A1
(43) Pub. Date: Nov. 27, 2008

(54) Electric device and tire condition monitoring apparatus

(76) Inventor: Michiya Katou, Ichinomiya-shi (JP)

Correspondence Address: Pearl Cohen Zedek Latzer, LLP, 1500 Broadway, 12th Floor, New York, NY, 10036, US

(21) Appl. No.: 11/882,785

(22) Filed: Aug. 6, 2007

(30) Foreign Application Priority Data
May 24, 2007 (JP) 2007-138210

(51) Int. Cl. H02J 7/00; G01M 17/02; G08B 21/00

(52) U.S. Cl. 340/442; 320/135; 73/146.5

(57) ABSTRACT

A tire condition monitoring apparatus having a transmitter and a receiver is disclosed. The transmitter incorporates a battery having a positive electrode and a negative electrode. The transmitter wirelessly transmits a signal including data representing the condition of a tire of a vehicle using electromotive force produced by the battery. The receiver receives the signal from the transmitter and processes the signal. The transmitter includes a refresh circuit that performs refresh by forcibly supplying an electric current to the positive and negative electrodes of the battery. The transmitter measures the electromotive force of the battery after such refresh. If the electromotive force of the battery has not been recovered, the transmitter sends a notification signal indicating insufficiency of the electromotive force of the battery to the receiver. In response to the notification signal, the receiver announces insufficient capacity of the battery to the driver of the vehicle by means of a warning device.

### BACKGROUND OF THE INVENTION

The present invention relates to an electric device and a tire condition monitoring apparatus, and, more particularly, to a technique that prolongs the life of a battery used in an electric device.

A pair of electrodes, or a positive electrode and a negative electrode, are provided in a battery, such as a lithium battery, which is used in various types of electric devices. Each of the electrodes includes a current collector and an active material layer secured to the current collector. The current collector collects carriers generated in the active material layer. If the active material layer is separated from the current collector, the charging and discharging capacity of the battery is decreased and performance of the battery is lowered. To solve this problem, Japanese Laid-Open Patent Publications Nos. 56-57261 and 7-135023 each describe a battery that improves bond strength produced between a current collector and an active material layer through chromate treatment or corona discharge treatment performed on a surface of the current collector. Also, Japanese Laid-Open Patent Publication No. 2000-48822 describes a battery that improves bond strength between a current collector and an active material layer through boehmite treatment performed on a surface of the current collector.

As to each of the above-described batteries, it is known that precipitate may deposit on and adhere to a surface of the positive electrode and a surface of the negative electrode and thus form a film as the time elapses. Such adhesion of the precipitate on the positive and negative electrodes lowers the charging and discharging capacity of the battery. In this case, even if the bond strength of the active material layer is improved with respect to the current collector as in the above-described techniques, the charging and discharging capacity of the battery decreases as the time elapses and the life of the battery shortens unavoidably.

### SUMMARY OF THE INVENTION

Accordingly, it is an objective of the present invention to provide an electric device and a tire condition monitoring apparatus that suppress adhesion of precipitate on a surface of an electrode of a battery and prolong the life of a battery.

To achieve the foregoing objective, and in accordance with a first aspect of the present invention, an electric device having a battery, a load device, and a refresh circuit is provided. The battery has a pair of electrodes, each of which includes a current collector and an active material layer. The load device is driven by the battery. The refresh circuit performs refresh, in which the refresh circuit forcibly supplies an electric current between the electrodes, thereby removing adhering matter from the electrodes.

According to this configuration, the electric current is forcibly supplied between the two electrodes so that adhering matter is removed from the electrodes. This prevents the charging and discharging capacity of the battery from lowering, and prolongs the life of the battery.

It is preferred that the refresh circuit supplies an electric current greater than the electric current that drives the load device between the electrodes.

This effectively removes the adhering matter from the electrodes.

The refresh circuit may include a load section that is connected to the battery and arranged in parallel with the load device, and a switch that operates to form a closed circuit including the load section and the battery.

According to this configuration, an electric current is supplied to the battery through operation of the switch so that the battery is refreshed.

The load section may be a resistor or a constant current circuit.

If the load section is a resistor or a constant current circuit, a simply configured refresh circuit is formed. This reduces the size of the electric device. If the constant current circuit is used as the load section, a constant current flows in the constant current circuit through operation of the switch regardless of the level of the voltage applied to each of the two ends of the refresh circuit.

The refresh circuit may perform the refresh if a predetermined condition is satisfied.

According to this configuration, the battery is periodically refreshed at predetermined time intervals if, for example, the predetermined condition is satisfied each time a predetermined time elapses. Thus, even when the load device is maintained in a non-used state, the adhering matter is prevented from depositing on the electrodes of the battery.

The refresh circuit may carry out the refresh periodically each time a predetermined time elapses.

According to this configuration, the battery is refreshed at predetermined time intervals. Thus, even if the load device is held in a non-used state, the adhering matter is prevented from depositing on the electrodes of the battery.

A voltage sensor may be further provided and detect the electromotive force of the battery when the load device is maintained in a driven state. In this case, the refresh circuit may perform the refresh if the electromotive force detected by the voltage sensor is less than or equal to a predetermined threshold value.

According to this configuration, the electromotive force of the battery is accurately detected. It is thus correctly determined whether the electromotive force of the battery is a value that can drive the load device.

A voltage sensor may be further provided that detects the electromotive force of the battery when the load device is held in a driven state. In this case, a determining section may also be provided that determines that the capacity of the battery is insufficient if the electromotive force detected by the voltage sensor is less than or equal to a predetermined threshold value.

According to this configuration, the battery is refreshed appropriately when needed.

The electric device according to the present invention may be a transmitter of a tire condition monitoring apparatus that monitors the condition of a tire of a vehicle.

According to this configuration, adhering matter is removed from an electrode of a battery incorporated in the tire condition monitoring apparatus.

In accordance with a second aspect of the present invention, a tire condition monitoring apparatus is provided. The tire condition monitoring apparatus includes a transmitter and a receiver. The transmitter is arranged in a tire of a vehicle, detects a condition of the tire, and transmits a signal indicating the detected condition of the tire. The receiver is mounted in a body of the vehicle and receives the signal indicating the condition of the tire. The transmitter includes a battery, a load device, and a refresh circuit. The battery has a pair of electrodes, each of which includes a current collector and an active material layer. The load device detects the condition of the tire and transmits the signal. The load device is driven by the battery. The refresh circuit performs refresh, in which the refresh circuit forcibly supplies an electric current between the electrodes, thereby removing adhering matter from the electrodes.

According to this configuration, adhering matter is removed from the electrodes of the battery that drives the transmitter of the tire condition monitoring apparatus of the vehicle. This allows the transmitter to maintain stable operation for a long time.

The transmitter includes a voltage sensor that detects an electromotive force of the battery when the load device is maintained in a driven state after the refresh has been performed and transmits a notification signal indicating insufficiency of the capacity of the battery if the electromotive force detected by the voltage sensor is less than or equal to a predetermined threshold value. The receiver includes an annunciator that announces the insufficiency of the capacity of the battery in response to the notification signal.

This allows the driver of the vehicle to correctly acknowledge that the transmitter needs to be replaced.

The receiver has a transmitting section that transmits an instruction signal that instructs the execution of the refresh. The transmitter has a receiving section that receives the instruction signal, and the refresh circuit performs the refresh if the receiving section receives the instruction signal.

This allows external control of the refresh of the battery.

### BRIEF DESCRIPTION OF THE DRAWINGS

FIG. 1 is a schematic view showing a tire condition monitoring apparatus according to one embodiment of the present invention;

FIG. 2 is a block diagram representing a transmitter and a receiver of the apparatus shown in FIG. 1;

FIG. 3 is a cross-sectional view showing the configuration of a battery incorporated in the transmitter shown in FIG. 2;

FIG. 4 is a block diagram representing a transmitter controller and a refresh circuit;

FIG. 5 is a circuit diagram representing the refresh circuit; and

FIG. 6 is a flowchart representing a refresh procedure performed by the transmitter.

### DETAILED DESCRIPTION OF THE PREFERRED EMBODIMENTS

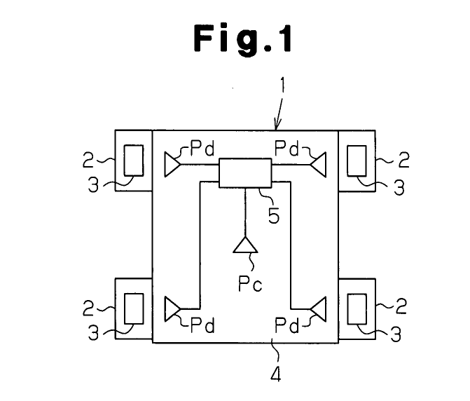

An electric device according to one embodiment of the present invention will now be explained with reference to FIGS. 1 to 6. In this embodiment, the electric device is a transmitter of a tire condition monitoring apparatus. As shown in FIG. 1, a tire condition monitoring apparatus includes four transmitters 3 and a receiver 5. The transmitters 3 are each mounted in one of four tires 2 of a vehicle 1. The receiver 5 is provided in a body frame 4 of the vehicle 1.

Each of the transmitters 3 is fixed to the corresponding one of the wheels in such a manner that the transmitter 3 is arranged in the corresponding tire 2. Each transmitter 3 monitors the condition of the corresponding tire 2, or measures the air pressure and the temperature in the corresponding tire 2. The transmitter 3 then wirelessly transmits a signal including data representing the monitored condition of the tire 2 to the receiver 5. Such monitoring of the condition of each tire 2 is carried out periodically at a first predetermined time interval. Transmission is carried out periodically at a second predetermined time interval, which is longer than the first time interval. However, if an abnormal condition is monitored in any one of the tires 2 (for example, an abnormal pressure drop or a rapid pressure change of the tires 2), the corresponding one of the transmitters 3 transmits necessary data immediately regardless of the time interval of periodic transmission of the transmitter 3. The receiver 5 receives the signal that has been wirelessly transmitted by the transmitter 3 and processes the received signal.

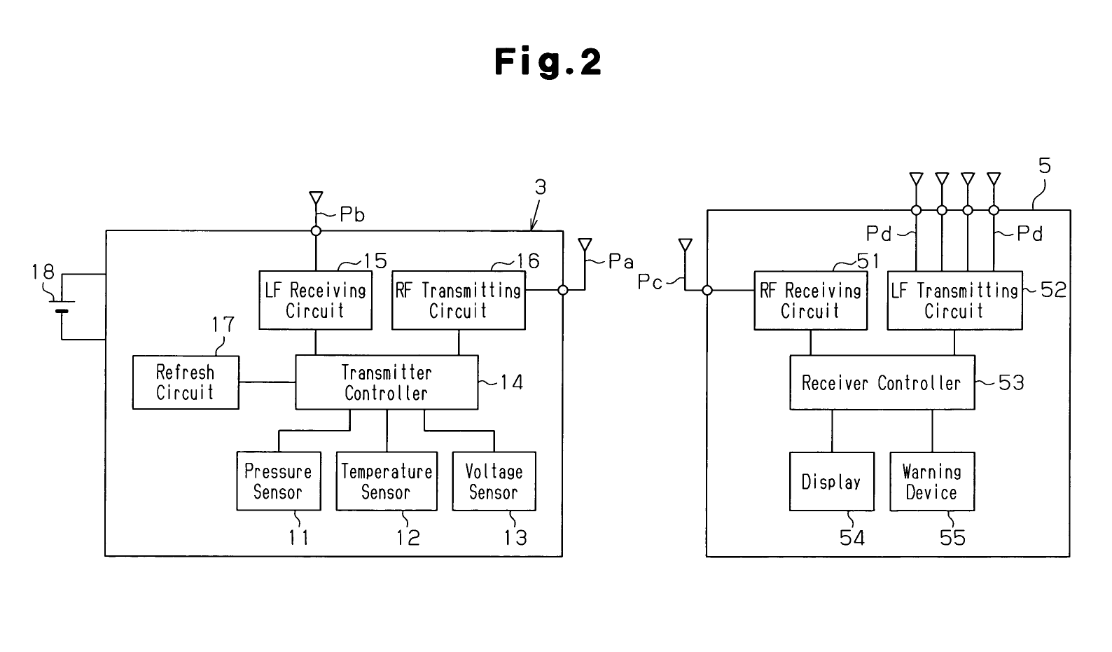

As illustrated in FIG. 2, each of the transmitters 3 has a pressure sensor 11, a temperature sensor 12, a voltage sensor 13, a transmitter controller 14, an LF receiving circuit 15 serving as a receiving section, an RF transmitting circuit 16, and a refresh circuit 17. The sensors 11 to 13, the transmitter controller 14, the LF receiving circuit 15, and the RF transmitting circuit 16 are load devices driven by a battery 18 incorporated in the transmitter 3 and connected to the battery 18 through non-illustrated cables.

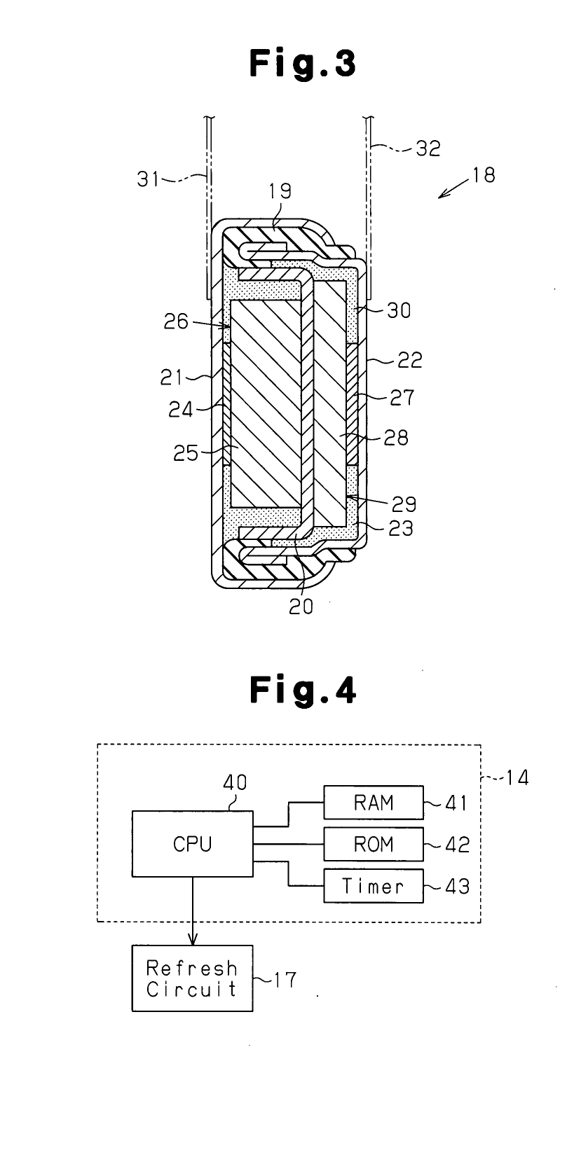

The battery 18 is a publicly known small-sized lithium battery. As shown in FIG. 3, the battery 18 has a positive electrode cover 21 and a negative electrode cover 22 that are engaged together through a gasket 19. A space 23 is defined by the positive electrode cover 21 and the negative electrode cover 22 and accommodates a pair of electrodes, which are a positive electrode 26 and a negative electrode 29. The positive electrode 26 includes a current collector 24 and a positive electrode active material layer 25. The current collector 24 is held in contact with the positive electrode cover 21. The positive electrode active material layer 25 is secured to the current collector 24. The negative electrode 29 includes a current collector 27 and a negative electrode active material layer 28. The current collector 27 is held in contact with the negative electrode cover 22. The negative electrode active material layer 28 is secured to the current collector 27. The space 23 is filled with electrolyte 30 and receives a separator 20, through which the two electrodes 26, 29 oppose each other. A positive electrode terminal 31 is secured to the positive electrode cover 21 and a negative electrode terminal 32 is secured to the negative electrode cover 22. The terminals 31, 32 are connected to the sensors 11 to 13, the transmitter controller 14, the LF receiving circuit 15, and the RF transmitting circuit 16 through non-illustrated cables. The sensors 11 to 13, the transmitter controller 14, the LF receiving circuit 15, and the RF transmitting circuit 16 are thus driven by the power supplied by the battery 18.

With reference to FIG. 2, the pressure sensor 11 measures the air pressure in the corresponding tire 2 and outputs air pressure data obtained through such measurement to the transmitter controller 14. The temperature sensor 12 measures the temperature in the tire 2 and sends temperature data obtained through measurement to the transmitter controller 14. The voltage sensor 13 measures electromotive force of the battery 18 and provides voltage data obtained through measurement to the transmitter controller 14. As illustrated in FIG. 4, the transmitter controller 14 has a CPU 40 serving as a determining section, a RAM 41, a ROM 42, and a timer 43. An ID code, or unique identifying information, is registered in the RAM 41. In accordance with the ID code, the receiver 5 identifies the transmitter 3. The transmitter controller 14 outputs data including the air pressure data, the temperature data, and the ID code to the RF transmitting circuit 16. The RF transmitting circuit 16 encodes and modulates the data provided by the transmitter controller 14 and then wirelessly sends an RF signal (a high-frequency signal) including the data to the receiver 5 through an RF transmitting antenna Pa.

The ROM 42 memorizes a threshold value V1 of the electromotive force of the battery 18. The threshold value V1 is set in correspondence with a minimum value of the voltage necessary for normally actuating the load devices 11 to 16 at a predetermined reference temperature. If the electromotive force of the battery 18 is less than or equal to the threshold value V1, it is determined that the capacity of the battery 18 is insufficient and the battery 18 is not suitable for use.

The ROM 42 further stores conversion data in accordance with which changes of the electromotive force of the battery 18 caused by fluctuation of the temperature in the associated tire 2 are corrected. The conversion data is used to convert the electromotive force of the battery 18, which is measured by the voltage sensor 13, to a value corresponding to the reference temperature in correspondence with the temperature in the tire 2, which is measured by the temperature sensor 12. The timer 43 measures time.

The refresh circuit 17 is connected to the transmitter controller 14 and refreshes the battery 18. Specifically, as the battery 18 is consumed, precipitate (adhering matter) adheres to a surface of each of the electrodes 26, 29 and forms a film. The refresh circuit 17 performs refresh so as to remove such adhering matter.

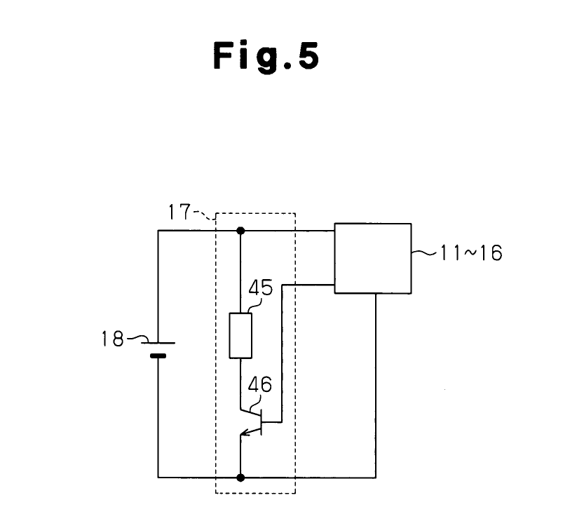

With reference to FIG. 5, the refresh circuit 17 is connected to the battery 18 and arranged in parallel with the load devices 11 to 16. The refresh circuit 17 includes a resistor 45 serving as a load section and a transistor 46 serving as a switch connected in series with the resistor 45. The resistor 45 has a resistance value sufficiently less than the sum of the internal resistances of the sensors 11 to 13, the transmitter controller 14, the LF receiving circuit 15, and the RF transmitting circuit 16.

A gate of the transistor 46 receives a high-level or low-level refresh signal from the transmitter controller 14. In the illustrated embodiment, an n-channel FET is used as the transistor 46. Thus, if a high-level refresh signal is input to the gate of the transistor 46, the transistor 46 is turned on. If a low-level refresh signal is input to the gate of the transistor 46, the transistor 46 is turned off.

When the transistor 46 is held in an ON state, a closed circuit including the resistor 45 and the battery 18 is formed. As a result, an electric current flows between the electrodes 26, 29 through the resistor 45 in correspondence with the electromotive force of the battery 18. In this manner, refresh is performed. As has been described, the resistance value of the resistor 45 is sufficiently less than the sum of the internal resistances of the sensors 11 to 13, the transmitter controller 14, the LF receiving circuit 15, and the RF transmitting circuit 16. Thus, a sufficiently great electric current flows between the electrodes 26, 29. Through such refresh, the precipitate (the adhering matter) adhered to the electrodes 26, 29 are removed and the electromotive force of the battery 18 is recovered.

Further, when the transistor 46 is held in an OFF state, the circuit including the battery 18 and the resistor 45 becomes open. This prevents a current of electricity through the resistor 45. In other words, a current of electricity through the refresh circuit 17 does not occur.

If the CPU 40 determines that the electromotive force of the battery 18 has not been recovered to a value greater than the threshold value after the refresh, the CPU 40 provides a notification signal (a warning signal) indicating insufficiency of the capacity of the battery 18 to the RF transmitting circuit 16. The RF transmitting circuit 16 wirelessly transmits an RF signal including the notification signal to the receiver 5 through the RF transmitting antenna Pa.

As illustrated in FIG. 2, the receiver 5 includes an RF receiving circuit 51, an LF transmitting circuit 52 serving as a transmitting section, a receiver controller 53, a display 54, and a warning device 55 serving as an annunciator, which are driven by a battery (not shown) mounted in the vehicle 1. The RF receiving circuit 51 receives a signal from any one of the transmitters 3 through an RF receiving antenna Pc. The RF receiving circuit 51 demodulates and decodes the received signal and thus obtains data. The RF receiving circuit 51 then outputs the data to the receiver controller 53. Based on the data provided by the RF receiving circuit 51, the receiver controller 53 acquires the air pressure and the temperature of the tire 2 corresponding to the transmitter 3 that has transmitted the signal. If the receiver controller 53 receives the notification signal from any one of the transmitters 3, the receiver controller 53 determines that the battery 18 of the transmitter 3 that has transmitted the signal is short of capacity.

The receiver controller 53 displays information regarding the air pressure and the temperature in the tire 2 on the display 54. The display 54 is arranged in the visible range of the driver of the vehicle 1. The receiver controller 53 further operates the warning device (the annunciator) 55 to announce abnormality of the air pressure and the temperature in the tire 2 and the insufficient capacity of the battery 18. A device that announces abnormality with sound or light, for example, is employed as the warning device 55. However, the display 54 serving as an annunciator may display the abnormality of the air pressure and the temperature in the tire 2 and the insufficient capacity of the battery 18.

LF transmitting antennas Pd are connected to the LF transmitting circuit 52 in correspondence with the transmitters 3. Each of the LF transmitting antennas Pd is arranged in the vicinity of the corresponding one of the transmitters 3, or, for example, in a wheel housing of the body frame 4. The receiver controller 53 transmits an LF signal (a low-frequency signal), or a control signal (an instruction signal), through the LF transmitting circuit 52 and the LF transmitting antennas Pd. Each transmitter 3 receives the LF signal from the corresponding LF transmitting antenna Pd through the associated LF receiving antenna Pb and the LF receiving circuit 15. In response to the LF signal, the transmitter controller 14 of the transmitter 3 operates in accordance with instruction indicated by the LF signal. For example, the transmitter controller 14 switches operating modes or performs refresh in response to the LF signal.

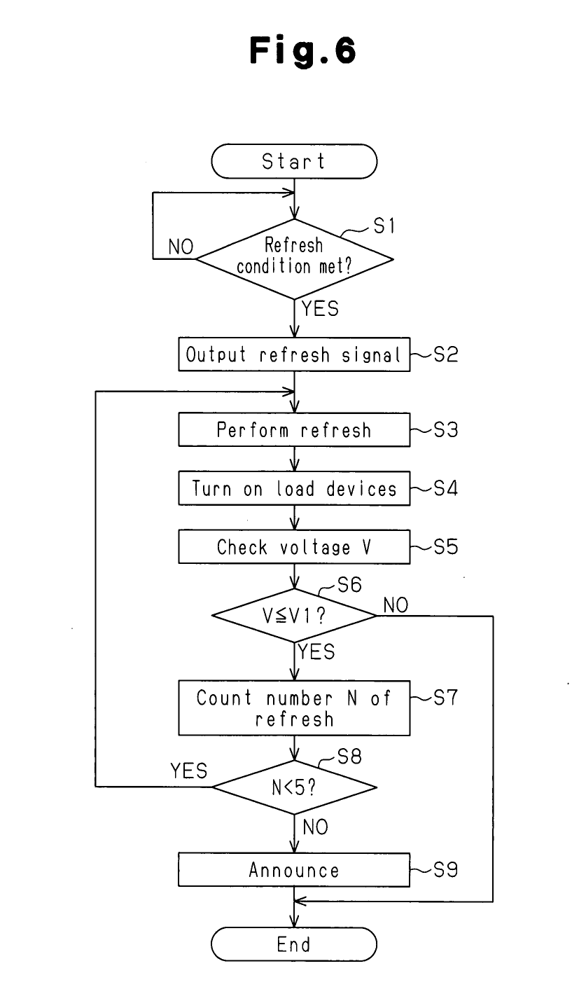

A procedure performed by the tire condition monitoring apparatus, which is configured as described above, will be explained with reference to FIG. 6. The routine represented by the flowchart of FIG. 6 is carried out in accordance with a program stored in the ROM 42.

In step S1, the CPU 40 determines whether any one of predetermined conditions for refresh has been satisfied. In the illustrated embodiment, the following three conditions A) to C) are set as the conditions for refresh.

A) An LF signal instructing execution of refresh has been provided by the receiver 5.

B) The periodical refresh must be carried out in accordance with the predetermined timing.

C) The electromotive force of the battery 18 in transmission has become less than or equal to the threshold value V1.

The condition A) is satisfied, for example, each time the traveling distance of the vehicle 1 reaches a predetermined value (for example, 300 km) or the duration of use of the vehicle 1 reaches a predetermined value. When the condition A) is satisfied, the receiver 5 provides the LF signal instructing execution of the refresh. The condition B) is satisfied each time the time measured by the timer 43 reaches a predetermined value (for example, a week) at which it is determined that the periodical refresh must be performed. To determine whether the condition C) is satisfied, the electromotive force of the battery 18 and the temperature in the tire 2 are measured when transmission is performed. The obtained electromotive force of the battery 18 is converted in accordance with the conversion data and the converted value is compared with the threshold value V1.

If any one of the conditions A) to C) is satisfied, the CPU 40 outputs a high-level refresh signal to the refresh circuit 17 in step S2.

Subsequently, in step S3, the refresh is carried out on the corresponding battery 18. The CPU 40 then outputs a low-level refresh signal to the refresh circuit 17. This ends the refresh of the battery 18.

Next, in steps S4 and S5, the CPU 40 operates the voltage sensor 13 to measure the electromotive force of the battery 18 with the load devices maintained in operation. In the illustrated embodiment, the measurement of the electromotive force of each battery 18 is performed while transmission is being carried out, or, with the RF transmitting circuit 16 held in a driven state. Then, in step S6, the CPU 40 compares the obtained electromotive force of the battery 18 with the threshold value V1. Also in this case, the measurement of the electromotive force of the battery 18 is converted in accordance with the conversion data and compared with the threshold value V1. If the electromotive force of the battery 18 is greater than the threshold value V1, it is determined that the electromotive force of the battery 18 has been recovered through the refresh. The CPU 40 thus suspends the current routine and resumes normal operation.

Contrastingly, if the electromotive force of the battery 18 is less than or equal to the threshold value V1, the CPU 40 increments the count value N set in the RAM 41 by one in step S7. In step S8, the CPU 40 determines whether the count value N is less than five. If the count value N is less than five, the CPU 40 repeats step S3 and repeatedly performs the refresh. If the count value N is greater than or equal to five, the CPU 40 wirelessly transmits a notification signal indicating insufficiency of the capacity of the battery 18 in step S9. On reception of the notification signal, the receiver 5 operates the warning device 55 to announce the insufficiency of the capacity of the battery 18. In other words, as long as the electromotive force of the battery 18 remains less than or equal to the threshold value V1, it is determined that the capacity of the battery 18 has not been recovered even after the refresh has been repeated for five times and the above-described notification is carried out.

The refresh of step S3 lasts for, for example, 0.2 milliseconds. If the refresh is repeatedly performed, such refresh is carried out at a time interval of one second.

The illustrated embodiment has the following advantages.

(1) Each battery 18 includes the positive electrode 26 and the negative electrode 29 that are opposed to each other through the separator 20 and arranged in the electrolyte 30. The positive electrode 26 has the positive electrode active material layer 25 secured to the current collector 24. The negative electrode 29 has the negative electrode active material layer 28 secured to the current collector 27. An electric current is forcibly supplied to the battery 18 so that the battery 18 is refreshed. This removes the adhering matter from the electrodes 26, 29 and prolongs the life of the battery 18.

(2) If the electromotive force of any one of the batteries 18 is less than or equal to the threshold value V1, the battery 18 is subjected to refresh. Thus, such refresh of the battery 18 is appropriately carried out when necessary.

(3) The refresh is periodically carried out on each of the batteries 18 at a predetermined time interval. Thus, for example, if the transmitters 3 are stored in a stopped and non-used state, deposition of the adhering matter on the electrodes 26, 29 of the batteries 18 is suppressed.

(4) If the electromotive force of the battery 18 cannot be recovered, the refresh is repeatedly performed for a plurality of times. This effectively removes the adhering matter from the electrodes 26, 29 and maximally recovers the electromotive force of the battery 18.

(5) The electromotive force of each battery 18 is converted in accordance with the conversion data based on the temperature in the corresponding tire 2 detected by the temperature sensor 12. Thus, regardless of fluctuation of the electromotive force of the battery 18 caused by the ambient temperature, the electromotive force of the battery 18 is optimally determined.

(6) The resistance value of the resistor 45 is sufficiently less than the sum of the internal resistances of the sensors 11 to 14, the transmitter controller 14, the LF receiving circuit 15, and the RF transmitting circuit 16. Thus, a great electric current is supplied between the electrodes 26, 29 so that the adhering matter is efficiently removed from the electrodes 26, 29.

(7) The electromotive force of the battery 18 is measured by the voltage sensor 13 with the load devices maintained in operation. It is thus accurately determined whether the electromotive force of the battery 18 is sufficiently great for driving the load devices.

(8) The refresh allows efficient use of the batteries 18 and long-term stable operation of the transmitters 3.

(9) If insufficiency of the capacity of any one of the batteries 18 cannot be recovered regardless of the refresh, the associated transmitter 3 transmits the notification signal to the receiver 5. In response to the notification signal, the receiver 5 operates the warning device 55 to announce the insufficiency of the capacity of the battery 18. This allows the driver of the vehicle 1 to correctly acknowledge that the transmitter 3 needs to be replaced.

(10) The refresh circuit 17 is formed by the resistor 45 and the transistor 46, or the switch, which is connected in series with the resistor 45. The refresh circuit 17 is connected also to each battery 18 and arranged in parallel with the load devices 11 to 16. That is, the refresh circuit 17 is simply configured and reduces the size of each transmitter 3.

The present invention is not restricted to the illustrated embodiment but may be embodied in the following modified forms.

Typically, an external controller for externally controlling the transmitters 3 is employed, for example, in a garage. The external controller is capable of transmitting an LF signal identical with or similar to the LF signal provided by the receiver 5. Thus, the external controller may transmit the LF signal (an instruction signal or a control signal) to the transmitters 3 and the transmitters 3 may perform the refresh in response to the LF signal.

Instead of converting the measured electromotive force of the battery 18 to a value corresponding to the reference temperature, the threshold value V1 may be altered in correspondence with the current temperature.

The resistor 45 may be replaced by a constant current circuit as a load section. In this case, a constant electric current flows in the refresh circuit 17 regardless of the value of the voltage applied to each of the two ends of the refresh circuit 17. This stabilizes the refresh current flowing in each battery 18 when the battery 18 is subjected to refresh.

The number of the repeated cycles of refresh is not restricted to five. That is, such number may be greater or less than five.

When the batteries 18 are exposed to high temperature, adhesion of precipitate to the electrodes 26, 29 is promoted. In this case, the refresh may be performed when the temperature in each tire 2 restores a normal value (for example, a normal environmental temperature of 20° C. to 40° C.) after having risen to a high level (for example, approximately 100° C.).

The vehicle 1 is not restricted to a four-wheel vehicle. That is, the illustrated embodiment may be embodied in a bicycle, a motorbike, a multiple-wheel bus or towed vehicle, or an industrial vehicle having the tires 2 (for example, a forklift).

The present invention is not restricted to the transmitters 3 of the tire condition monitoring apparatus. However, the present invention may be applied to various types of electric devices that employ batteries. Further, the battery on which the refresh is performed is not restricted to the lithium battery.

What is claimed is:

1. An electric device comprising:
a battery having a pair of electrodes, each of the electrodes including a current collector and an active material layer;
a load device driven by the battery; and
a refresh circuit that performs refresh, in which the refresh circuit forcibly supplies an electric current between the electrodes, thereby removing adhering matter from the electrodes.

2. The device according to claim 1, wherein, when performing the refresh, the refresh circuit supplies, between the electrodes, an electric current greater than the electric current that drives the load device.

3. The device according to claim 1, wherein the refresh circuit includes:
a load section connected to the battery and arranged in parallel with the load device; and
a switch that operates to form a closed circuit including the load section and the battery.

4. The device according to claim 3, wherein the load section is a resistor or a constant current circuit.

5. The device according to claim 1, wherein the refresh circuit performs the refresh when a predetermined condition is satisfied.

6. The device according to claim 5, wherein the refresh circuit periodically performs the refresh each time a predetermined time elapses.

7. The device according to claim 6, further comprising a voltage sensor that detects an electromotive force of the battery when the load device is maintained in a driven state, wherein, if the electromotive force detected by the voltage sensor is less than or equal to a predetermined threshold value, the refresh circuit performs the refresh.

8. The device according to claim 1, further comprising:
a voltage sensor that detects an electromotive force of the battery when the load device is maintained in a driven state after the refresh has been performed; and
a determining section that determines that a capacity of the battery is insufficient if the electromotive force detected by the voltage sensor is less than or equal to a predetermined threshold value.

9. The device according to claim 1, wherein the electric device is a transmitter of a tire condition monitoring apparatus that monitors a condition of a tire of a vehicle.

10. A tire condition monitoring apparatus comprising:
a transmitter that is arranged in a tire of a vehicle, detects a condition of the tire, and transmits a signal indicating the detected condition of the tire; and
a receiver that is mounted in a body of the vehicle and receives the signal indicating the condition of the tire,
wherein the transmitter includes:
a battery having a pair of electrodes, each of the electrodes including a current collector and an active material layer;
a load device that detects the condition of the tire and transmits the signal, the load device being driven by the battery; and
a refresh circuit that performs refresh, in which the refresh circuit forcibly supplies an electric current between the electrodes, thereby removing adhering matter from the electrodes.

11. The apparatus according to claim 10, wherein the transmitter includes a voltage sensor that detects an electromotive force of the battery when the load device is maintained in a driven state after the refresh has been performed and transmits a notification signal indicating insufficiency of the capacity of the battery if the electromotive force detected by the voltage sensor is less than or equal to a predetermined threshold value, and
wherein the receiver includes an annunciator that announces the insufficiency of the capacity of the battery in response to the notification signal.

12. The apparatus according to claim 10, wherein the receiver has a transmitting section that transmits an instruction signal that instructs the execution of the refresh, and
wherein the transmitter has a receiving section that receives the instruction signal, and the refresh circuit performs the refresh if the receiving section receives the instruction signal.
